(19) United States
(12) Patent Application Publication
(10) Pub. No.: US 2002/0143844 A1
(43) Pub. Date: Oct. 3, 2002

(54) Computer system with two operating systems

(76) Inventor: Wen-Sung Tsai, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/819,753

(22) Filed: Mar. 29, 2001

(51) Int. Cl. G06F 9/00

(52) U.S. Cl. 709/102

(57) ABSTRACT

A computer system includes a processor for executing a program, a main memory for storing programs and data, a memory for storing a basic input/output system (BIOS), a first operating system, and at least one application program and a hard disk for storing a second operating system. When the computer system is turned on, the BIOS is loaded into the main memory to perform a system testing process, and then the computer system can choose to load the first operating system into the main memory so as to execute the application program stored in the memory or load the second operating system into the main memory so as to execute the second operating system. The first operating system is only capable of executing the application program stored in the memory.

### FIELD OF THE INVENTION

The present invention relates to a computer system, and more particularly, to a computer system having two operating systems, wherein one of the two is stored in the memory to shorten the start time.

### DESCRIPTION OF THE PRIOR ART

Computers are very popular devices in information transmission today. Because windows operating systems develop quickly, the more powerful operating systems are, the longer it takes to load the operating system.

It is very inconvenient for computer users to wait for a long time to check a calendar or memorandum data.

Please refer to FIG. 1. FIG. 1 is a function diagram of a computer system according to the prior art method. The computer system comprises a processor for executing programs, a main memory for storing the programs and data used by the processor, a memory for storing a basic input/output system (BIOS), a hard disk for storing an operating system, application programs and data, an input device, and a display device for controlling the operating system and the application programs.

When the computer system is turned on, the BIOS is loaded in the main memory and a system test is executed. Then, the computer system loads the operating system stored in the hard disk in main memory to open and execute the application programs stored in the hard disk.

Because the process speed of the hard disk is lower than that of other kinds of memory, such as ROM, RAM, flash memory and so on, and the operating system is windows and powerful, the time when loading in main memory is very long. It is too long for users to wait for the computer system to start.

### SUMMARY OF THE INVENTION

It is therefore a primary objective of the present invention to provide a computer system having two operating systems, wherein one operating system is stored in memory, shortening the loading time.

According to the claimed invention, the computer system comprises a processor for executing programs, a main memory for storing the programs and data used by the processor, a memory for storing a basic input/output system (BIOS), a hard disk for storing an operating system, application programs and data, an input device, and a display device for controlling the operating system and the application programs. The method comprises using the computer system with two operating systems. The first operating system is stored in the memory to control the computer system.

It is an advantage of the present invention that the computer system uses the two operating systems to start. Therefore, users do not experience the problems that occur due to the computer's long starting time.

These and other objectives and advantages of the present invention will no doubt become obvious to those of ordinary skill in the art after having read the following detailed description of the preferred embodiment that is illustrated in the various figures and drawings.

### BRIEF DESCRIPTION OF THE DRAWINGS

FIG. 1 is a functional diagram according to the prior art.

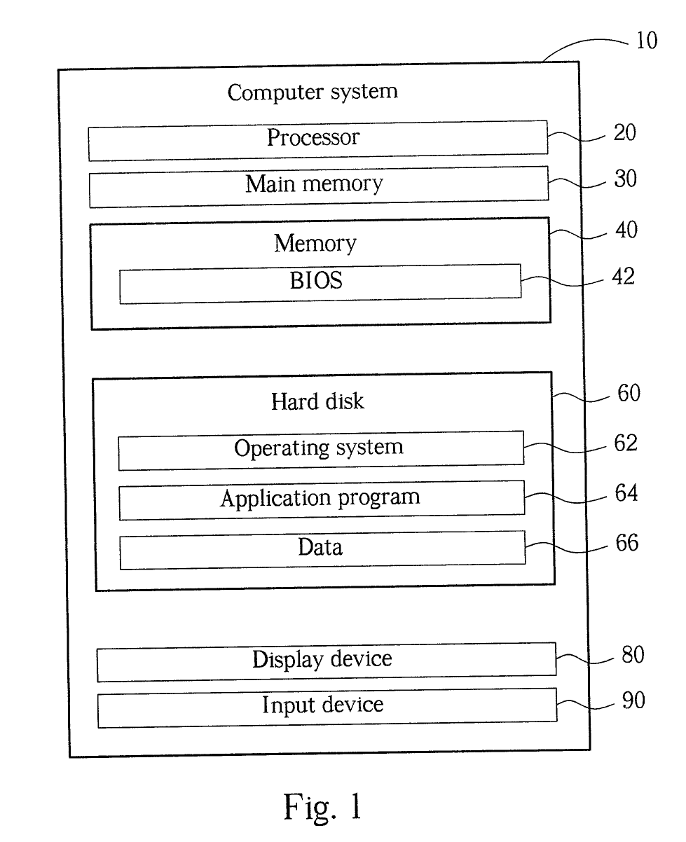

FIG. 2 is a functional diagram of a computer system according to the present invention.

### DETAILED DESCRIPTION OF THE PREFERRED EMBODIMENT

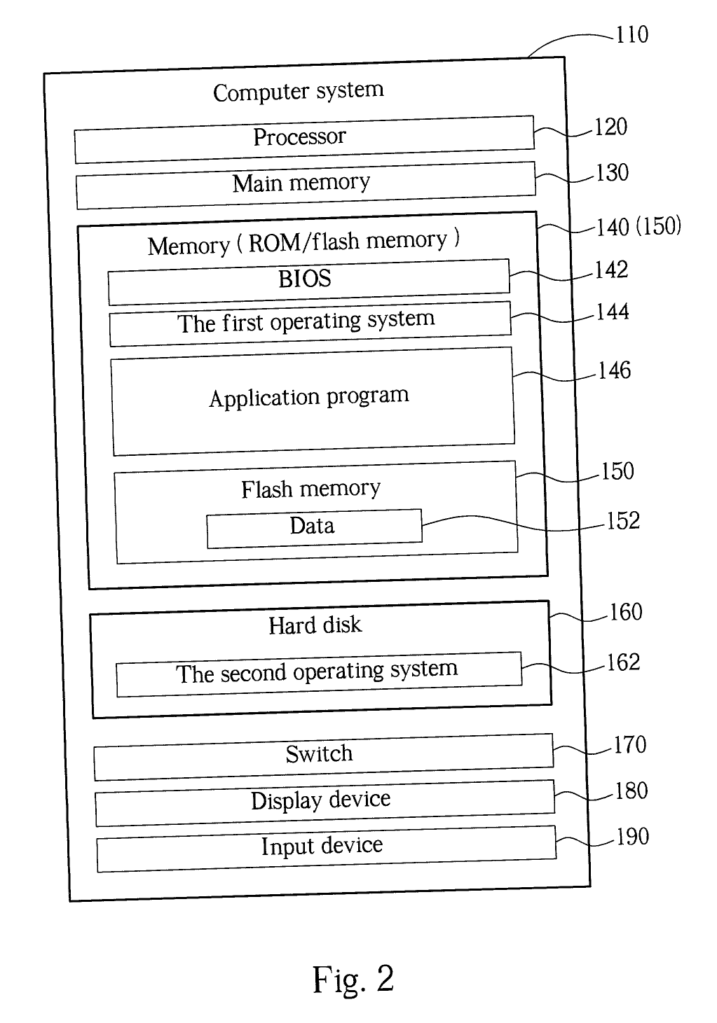

Please refer to FIG. 2. FIG. 2 is a cross-sectional diagram of a computer system according to the present invention. The computer system comprises a processor for executing programs, a main memory for storing the programs and data for the processor to use, a hard disk for storing a second operating system, a memory for storing a BIOS, a first operating system, and at least an application program.

When the computer system starts, the BIOS is loaded in main memory to execute a system process test. The computer system can choose to load the first operating system into main memory, so as to open and execute the application program stored in memory. Or, the computer can choose to load the second operating system into main memory, so as to execute the second operating system, only allowing the first operating system to execute the application program stored in memory.

As shown in FIG. 2, the memory can be replaced by ROM and flash memory so as to store the BIOS, the first operating system, the application program and the data required by the application program in the memory.

When the computer system executes the second operating system stored in the hard disk, the second operating system is capable of writing data into the flash memory or reading data from the flash memory.

The computer system has a switch for selecting to open the first operating system stored in the memory (ROM or flash memory) or the second operating system stored in the hard disk, a display device for displaying an image picture, and an input device.

The user can use the display device and the input device to control the application program in the memory, wherein the application program could be a calendar, phone book, memorandum, or other application program.

Compared with the prior art computer system, the memory (ROM or flash memory) of the computer system according to present invention stores the first operating system. When the user only needs to read some basic data, they can open the computer system quickly by opening the first operating system, shortening the time they must wait.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A computer system comprising:
a processor for executing a program;
a main memory for storing programs and data;
a memory for storing a basic input/output system (BIOS), a first operating system, and at least one application program; and
a hard disk for storing a second operating system;
wherein when the computer system is turned on, the BIOS is loaded into the main memory to perform a system testing process, and then the computer system is capable of choosing to load the first operating system into the main memory so as to execute the application program stored in the memory or load the second operating system into the main memory so as to execute the second operating system, the first operating system being only capable of executing the application program stored in the memory.

2. The computer system of claim 1 wherein the memory is a flash memory for storing data required by the application program.

3. The computer system of claim 2 wherein when the computer system is executing the second operating system, the second operating system is capable of writing data into the flash memory or reading data from the flash memory.

4. The computer system of claim 1 wherein the memory is a read-only memory for storing data required by the application program.

5. The computer system of claim 4 wherein when the computer system is executing the second operating system, the second operating system is capable of writing data into the read-only memory or reading data from the read-only memory.

6. The computer system of claim 1 further comprising a switch for selecting the first operating system or the second operating system.

7. The computer system of claim 1 further comprising an input device and a display device for displaying an image picture, wherein the application program is controlled by the input device and the display device.

8. The computer system of claim 1 wherein the application program is a calendar, a phone book or a memorandum application program.

9. The computer system of claim 1 wherein the main memory is a DRAM.
